(19) United States
(12) Patent Application Publication
(10) Pub. No.: US 2026/0048459 A1
(43) Pub. Date: Feb. 19, 2026

(54) DRAINAGE PLATE BOLT DISMOUNTING DEVICE

(71) Applicants: Guangdong Power Grid Co., Ltd., Guangzhou (CN); Heyuan Power Supply Bureau of Guangdong Power Grid Corporation, Heyuan (CN); Electric Power Research Institute of Guangdong Power Grid Co., Ltd., Guangzhou (CN)

(72) Inventors: Tuo ZENG, Heyuan (CN); Weiyan LIAO, Heyuan (CN); Jiangfeng QIAO, Heyuan (CN); Ruizhi LUO, Heyuan (CN); Peijie LIU, Heyuan (CN); Junhui CHEN, Heyuan (CN); Yongqin LI, Heyuan (CN); Ben SU, Heyuan (CN); Wei SUN, Heyuan (CN); Guohai ZENG, Heyuan (CN)

(21) Appl. No.: 19/001,341

(22) Filed: Dec. 24, 2024

(30) Foreign Application Priority Data
Aug. 14, 2024 (CN) 202411115566.9

(51) Int. Cl. B23P 19/06; H04N 7/18

(52) U.S. Cl. CPC B23P 19/069; H04N 7/18

(57) ABSTRACT

A drainage plate bolt dismounting device is provided, which relates to the technical field of overhead high-voltage transmission lines, and includes a supporting body, a Y-axis moving assembly, an X-axis moving assembly, a mounting and dismounting assembly and a monitoring component. In the device, a first base plate is connected to a T-shaped cable clip, a first driving mechanism is arranged on the first base plate, the first driving mechanism is connected to the supporting body, and can drive the supporting body to move in a first straight line direction; the X-axis moving assembly is connected to the supporting body, a second driving mechanism is arranged on a second base plate, the second driving mechanism is connected to an adapter structure, and can drive the adapter structure to move in a second straight line direction; the mounting and dismounting assembly is connected to the adapter structure.

### CROSS-REFERENCE TO RELATED APPLICATION

The present application claims priority to Chinese Patent Application No. 202411115566.9, filed with the China National Intellectual Property Administration (CNIPA) on Aug. 14, 2024, the disclosure of which is incorporated herein by reference in its entirety.

### TECHNICAL FIELD

The present application relates to the technical field of overhead high-voltage transmission lines, and in particular to a drainage plate bolt dismounting device.

### BACKGROUND

In power grids, it is often required to connect branch lines in parallel or to connect the ground, i.e., drain, at present, when dealing with the problem of drainage line connection, drainage cable clips are generally used for power outage operations or equipotential operations. Currently common drainage line connections are realized by wire winding, T-shaped cable clips (also referred to as T-connector), parallel groove clamps (C-shaped cable clips, also referred to as C-shape connector), etc. T-shaped cable clips are mainly used in overhead power lines or substation lines, mainly to introduce, in a “T”-shaped manner, branch lines on the main line. The T-shaped cable clip is divided into a drainage plate and a fixation cable clip, the fixation cable clip is connected to the main cable line, and the drainage plate is connected to the branch cable lines. The fixation cable clip and the drainage plate are connected by two positioning bolts.

Due to the harsh working environment of overhead high-voltage transmission lines, some factors such as ice coating and breeze vibration will cause the lines to vibrate, which in turn causes the bolts of the drainage plate of the T-shaped cable clip to loosen. As a result, the resistance increases due to the poor contact between the drainage plates, causing the temperature of the drainage plates to rise and the oxidation of the contact surfaces to intensify, which will cause the drainage plates to burn out and disconnection accidents to occur, and has a serious impact on the safe and stable operation of the power grid.

Therefore, it is necessary to dismount, inspect and maintain the drainage plates and fixation cable clips of the T-shaped cable clips in a timely manner. At present, the mounting and dismounting processes of the drainage plates mainly rely on manual operation. The operator needs to hang a soft ladder, climb up the soft ladder to perform equipotential operations, and then hang a pulley to tie the tension rope and arc extinguishing rope to the drainage line, and then, loosen the bolts on the drainage line, and the personnel on the ground reclaim the drainage line. The operator goes down the soft ladder and restores the site. To reinstall the drainage line, the above process needs to be repeated, so the work process is complicated and time-consuming. In addition, the operators need to perform equipotential operations and operate at high altitude, which is dangerous.

### SUMMARY

An aspect of the present invention is to provide a drainage plate bolt dismounting device to address the technical issues of low efficiency and poor safety in manual dismounting of drainage plate bolts in the conventional technology.

As conceived above, the technical solution adopted by the present invention is as follows.

A drainage plate bolt dismounting device is provided, which includes: a supporting body, a Y-axis moving assembly, an X-axis moving assembly, a mounting and dismounting assembly and a monitoring component.

The Y-axis moving assembly includes a first base plate and a first driving mechanism. The first base plate is connected to a T-shaped cable clip, the first driving mechanism is arranged on the first base plate, and the first driving mechanism is connected to the supporting body and can drive the supporting body to move in a first straight line direction. The X-axis moving assembly is connected to the supporting body.

The X-axis moving assembly includes a second base plate, a second driving mechanism and an adapter structure, the second driving mechanism is arranged on the second base plate, and the second driving mechanism is connected to the adapter structure and can drive the adapter structure to move in a second straight line direction.

The mounting and dismounting assembly is connected to the adapter structure. The mounting and dismounting assembly includes a connecting plate, a third driving mechanism and a mounting and dismounting sleeve. The third driving mechanism can drive the connecting plate to move in a third straight line direction, the mounting and dismounting sleeve is arranged on the connecting plate, the mounting and dismounting sleeve is provided with a magnetic attraction part therein, and the magnetic attraction part can attract a to-be-dismounted bolt.

The monitoring component includes a control body and a visual camera. The visual camera is connected to the supporting body and faces the to-be-dismounted bolt. The visual camera can acquire an image of a to-be-dismounted bolt, and determine three-dimensional coordinates of the to-be-dismounted bolt based on the image of the to-be-dismounted bolt, and upload the three-dimensional coordinates to the control body.

Preferably, the first driving mechanism includes a first sliding table, a first mounting seat, a first screw rod, a first motor and two first fixed seats. The two first fixed seats are arranged opposite to each other on the first base plate, and two ends of the first screw rod are connected to the two first fixed seats respectively. The first motor can drive the first screw rod to rotate around its own axis, the first sliding table is threadedly connected to the first screw rod, the first mounting seat is fixedly connected to the top of the first sliding table, and the first mounting seat is connected to the supporting body.

Preferably, the first driving mechanism further includes a first driven wheel, a first driving wheel and a first synchronous belt. An end of the first screw rod is connected to the first driven wheel, an end of the first motor is connected to the first driving wheel, and the first driving wheel and the first driven wheel are connected through the first synchronous belt.

Preferably, the first driving mechanism further includes two first guide rods. The two first guide rods are arranged parallel to the first screw rod and are distributed on two sides of the first screw rod, and two ends of each of the two first guide rods are connected to the first fixed seats respectively. The first sliding table is slidably connected to the first guide rods

Preferably, at least one of the first guide rods is provided with a limiter.

Preferably, the second driving mechanism includes a second sliding table, a second screw rod, a second motor and two second fixed seats. The two second fixed seats are arranged opposite to each other at the bottom of the second base plate, two ends of the second screw rod are connected to the two second fixed seats respectively, the second motor can drive the second screw rod to rotate around its own axis, the second sliding table is threadedly connected to the second screw rod, and the adapter structure is fixedly connected to the bottom of the second sliding table.

Preferably, two bearing plates are arranged on the top of the second base plate, each of the bearing plates includes a horizontal plate and a vertical plate integrally formed, the horizontal plate and the vertical plate are arranged perpendicular to each other, the horizontal plate is fixedly connected to the second base plate, and the vertical plate is fixedly connected to the supporting body.

Preferably, the mounting and dismounting sleeve includes a sleeve body and a connecting clip shaft. One end of the connecting clip shaft is connected to the sleeve body, the other end of the connecting clip shaft is connected to the connecting plate, a spring is sleeved on the connecting clip shaft, one end of the spring abuts against the sleeve body, and the other end of the spring abuts against the connecting plate.

Preferably, the third driving mechanism includes an adapter plate and a third motor. The adapter plate is fixedly connected to the adapter structure, the adapter plate is provided with a guide groove, and the guide groove extends in the third straight line direction. The connecting plate is correspondingly provided with a guide protrusion, the guide protrusion is slidably connected to the guide groove, a telescopic end of the third motor is connected to the connecting plate, and the third motor can drive the connecting plate to move along the guide groove.

Preferably, two mounting and dismounting sleeves are provided, and the two mounting and dismounting sleeves are arranged at an interval in the third straight line direction.

Beneficial effects of the present invention are as follows.

In the drainage plate bolt dismounting device proposed in the present invention, a picture of the to-be-dismounted bolt on the T-shaped cable clip or the mounting position of the to-be-dismounted bolt is taken by using a visual camera, and three-dimensional coordinates of the position are calculated through an algorithm. After the coordinates are fed back, the Y-axis moving assembly, the X-axis moving assembly and the mounting and dismounting assembly are controlled by the control body to drive the mounting and dismounting sleeve to a specified position, and the magnetic attraction part of the mounting and dismounting sleeve attracts the to-be-dismounted bolt, so as to realize the dismounting and mounting of the to-be-dismounted bolt, which replaces the conventional manual mounting and dismounting process of the bolt, saves time and effort, and improves the work efficiency; avoids the operation personnel's performing equipotential and high-altitude operations, reduces the danger and improves the safety of the work.

### BRIEF DESCRIPTION OF DRAWINGS

FIG. 1 is a schematic structural diagram of a T-shaped cable clip provided in an embodiment of the present invention;

FIG. 2 is an isometric view one of a drainage plate bolt dismounting device provided in an embodiment of the present invention;

FIG. 3 is an isometric view two of a drainage plate bolt dismounting device provided in an embodiment of the present invention;

FIG. 4 is a front view of a drainage plate bolt dismounting device provided in an embodiment of the present invention;

FIG. 5 is a schematic structural diagram of a Y-axis moving assembly provided in an embodiment of the present invention;

FIG. 6 is a schematic structural diagram of an X-axis moving assembly provided in an embodiment of the present invention;

FIG. 7 is a schematic structural diagram of a mounting and dismounting assembly provided in an embodiment of the present invention;

FIG. 8 is a schematic diagram showing a part of the structure of the mounting and dismounting assembly provided in an embodiment of the present invention; and

FIG. 9 is a schematic structural diagram of a mounting and dismounting sleeve provided in an embodiment of the present invention.

### REFERENCE NUMERALS LIST

1 supporting body
2 T-shaped cable clip
3 retaining module
4 drainage plate moving device
11 Y-axis moving assembly
12 rack
13 X-axis moving assembly
14 adapter plate
15 mounting and dismounting sleeve
16 visual camera
111 first base plate
112 first fixed seat
113 first motor plate
114 first motor
115 first screw rod
116 first guide rod
117 first driven wheel
118 first driving wheel
119 first synchronous belt
1110 first sliding table
1111 first mounting seat
1112 second mounting seat
131 bottom plate
132 second fixed seat
133 second motor plate
134 second motor
135 second screw rod
136 second guide rod
137 second driven wheel
138 second driving wheel
139 second synchronous belt
1310 second sliding table
1312 adapter structure
1313 second base plate
141 guide groove
142 transfer plate
143 third motor
144 transition plate
145 connecting plate
146 guide protrusion
151 connecting clip shaft
152 sleeve body
153 spring
154 magnetic attraction part

### DETAILED DESCRIPTION

Embodiments of the present invention is described in detail hereinafter, and examples of the embodiments are shown in the drawings, in which the same or similar reference numerals throughout represent the same or similar elements or elements with the same or similar functions. The embodiments described below with reference to the drawings are exemplary and are intended to be used to explain the present invention, and should not be construed as limiting the present invention.

In the description of the present invention, it is to be noted that, unless otherwise clearly specified and limited, the terms “connected to each other”, “connected” or “fixed” are to be construed in a broad sense, for example, as permanently connected or detachably connected or integrally formed; mechanically connected or electrically connected; directly connected to each other or indirectly connected to each other via an intermediary; or internally connection of two components or interaction relationship between two components. For the person of ordinary skill in the art, meanings of the above terms in the present invention may be construed according to specific circumstances.

In the present invention, unless otherwise clearly specified and limited, the first feature “above” or “below” the second feature can include the first and second features directly contacting each other, and can also include the first and second features not directly contacting each other but contacting each other through another feature between them. Moreover, the first feature “on”, “above” and “over” the second feature include the first feature being directly on, above, over and diagonally on, above, over the second feature, or simply means that the first feature is higher in level than the second feature. The first feature “under”, “below” and “underneath” the second feature include the first feature being directly under, below, underneath and diagonally under, below, underneath the second feature, or simply means that the first feature is lower in level than the second feature.

The technical solutions of the present invention are further explained below in conjunction with the drawings and through embodiments.

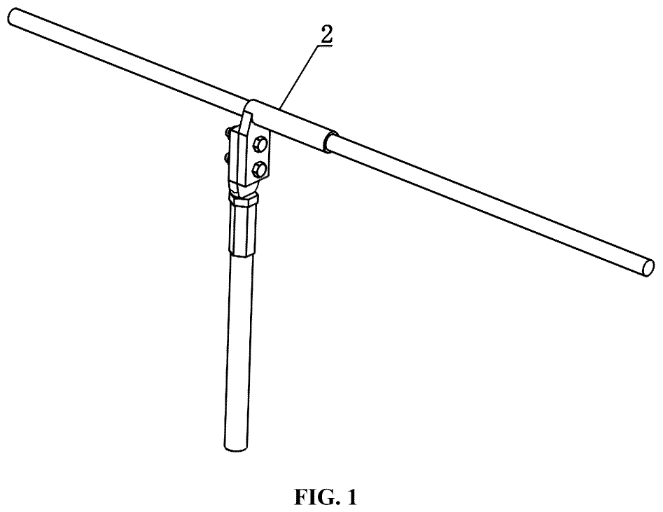

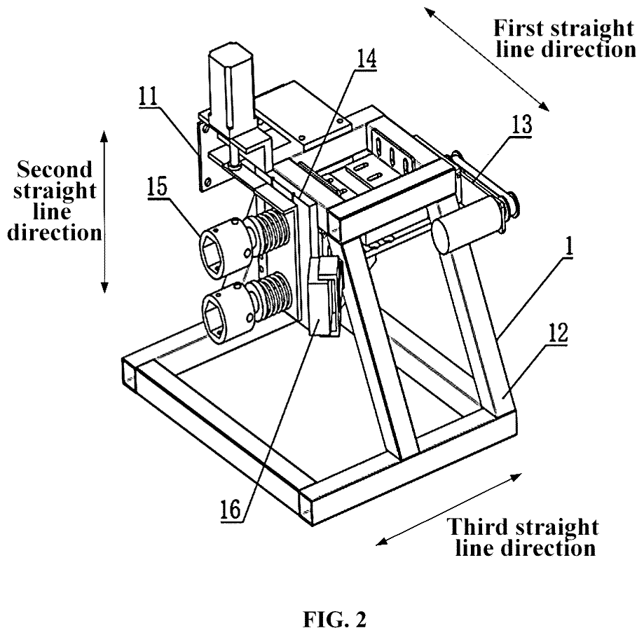

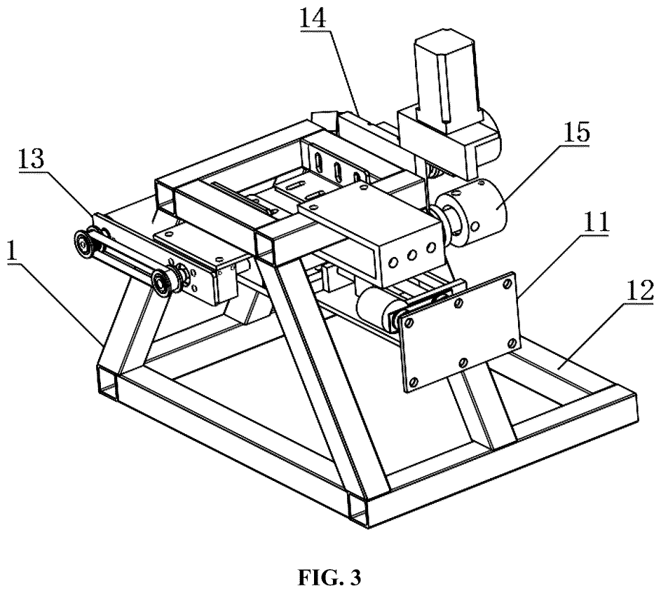

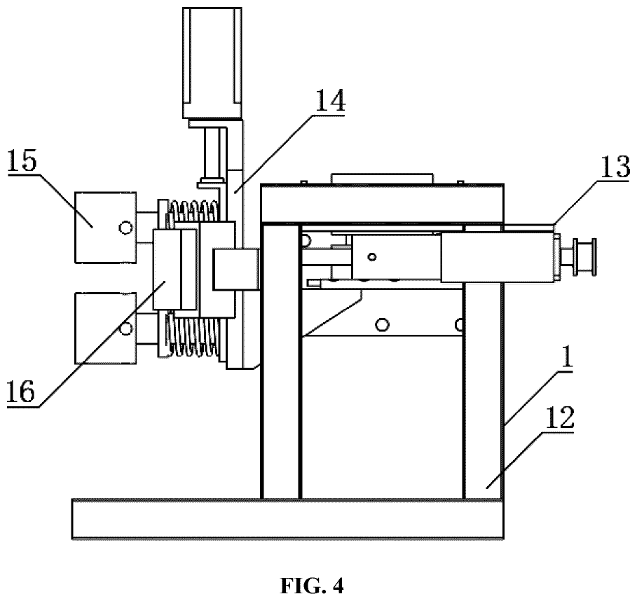

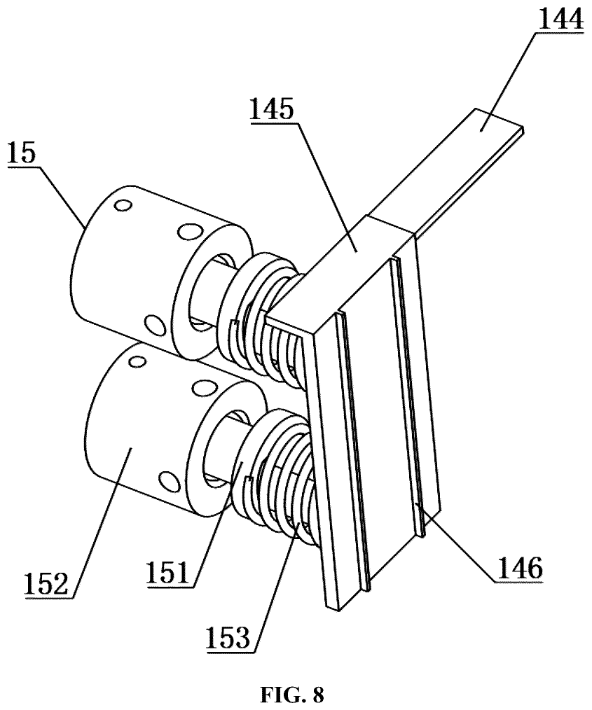

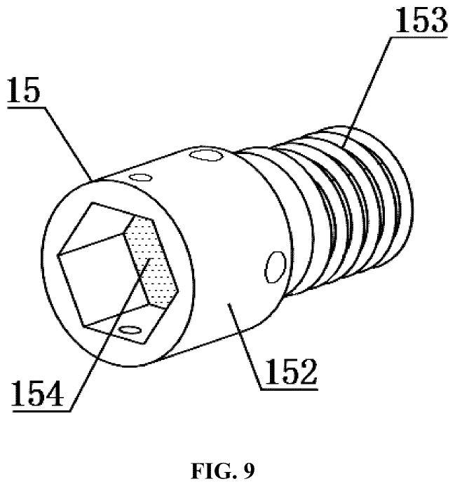

Referring to FIG. 1 to FIG. 9, the drainage plate bolt dismounting device provided in the embodiment of the present invention includes a supporting body 1, a Y-axis moving assembly 11, an X-axis moving assembly 13, a mounting and dismounting assembly and a monitoring component. The Y-axis moving assembly 11 includes a first base plate 111 and a first driving mechanism. The first base plate 111 is connected to a T-shaped cable clip 2, the first driving mechanism is arranged on the first base plate 111, and the first driving mechanism is connected to the supporting body 1 and can drive the supporting body 1 to move in a first straight line direction. The X-axis moving assembly 13 is connected to the supporting body 1. The X-axis moving assembly 13 includes a second base plate 1313, a second driving mechanism and an adapter structure 1312, the second driving mechanism is arranged on the second base plate 1313, and the second driving mechanism is connected to the adapter structure 1312 and can drive the adapter structure 1312 to move in a second straight line direction. The mounting and dismounting assembly is connected to the adapter structure 1312. The mounting and dismounting assembly includes a connecting plate 145, a third driving mechanism and a mounting and dismounting sleeve 15. The third driving mechanism can drive the connecting plate 145 to move in a third straight line direction, the mounting and dismounting sleeve 15 is arranged on the connecting plate 145, the mounting and dismounting sleeve 15 is provided with a magnetic attraction part 154 therein, and the magnetic attraction part 154 can attract a to-be-dismounted bolt. The monitoring component includes a control body and a visual camera 16. The visual camera 16 is connected to the supporting body 1 and faces the to-be-dismounted bolt. The visual camera 16 can acquire an image of a to-be-dismounted bolt, and determine three-dimensional coordinates of the to-be-dismounted bolt based on the image of the to-be-dismounted bolt, and upload the three-dimensional coordinates to the control body.

Herein, it is defined that the first straight line direction, the second straight line direction and the third straight line direction are perpendicular to each other, and the third straight line direction is a vertical direction. The first straight line direction and the second straight line direction are located in the same horizontal plane. For the convenience of description in conjunction with the drawings, the directions below are described in terms of the directions shown in the drawings, but are not limited thereto.

The supporting body 1 includes a rack 12 formed by welding multiple supporting rods, and the rack 12 has both high stability and high space utilization rate. The specific shape of the rack 12 is not limited here, and it is only required to ensure that the rack 12 can be connected to the T-shaped cable clip 2. In order to facilitate the connection, a retaining module 3 is arranged between the rack 12 and the T-shaped cable clip 2, thereby playing the role of transition connection.

Referring to FIG. 1, the T-shaped cable clip 2 includes a horizontally extending main section and a vertically extending branch section. The main section is connected to a main cable line, and a fixation cable clip is arranged at the bottom of the main section; drainage lines are connected to the branch section, and a drainage plate is arranged at the top of the branch section. The fixation cable clip and the drainage plate are each provided with a threaded hole. The fixation cable clip is provided with a groove, and the drainage plate is provided with a protrusion corresponding to the groove. While installing the drainage plate, the drainage plate and the fixation cable clip are aligned by matching the protrusion and the groove to ensure that the threaded hole in the drainage plate can be aligned with that in the fixation cable clip. The to-be-dismounted bolt is inserted into the threaded holes to fix the drainage plate and the fixation cable clip. The end of the to-be-dismounted bolt is locked through a locking nut.

In the drainage plate bolt dismounting device proposed in the present invention, a picture of the to-be-dismounted bolt on the T-shaped cable clip 2 or the mounting position of the to-be-dismounted bolt is taken by using a visual camera 16, and three-dimensional coordinates of the position are calculated through an algorithm. After the coordinates are fed back, the Y-axis moving assembly 11, the X-axis moving assembly 13 and the mounting and dismounting assembly are controlled by the control body to drive the mounting and dismounting sleeve 15 to a specified position, and the magnetic attraction part 154 of the mounting and dismounting sleeve 15 attracts the to-be-dismounted bolt, so as to realize the dismounting and mounting of the to-be-dismounted bolt, which replaces the conventional manual mounting and dismounting process of the bolt, saves time and effort, and improves the work efficiency; avoids the operation personnel's performing equipotential and high-altitude operations, reduces the danger and improves the safety of the work. In this embodiment, the conventional magnet may be used as the magnetic attraction part 154. In other embodiments, the magnetic attraction part 154 may also be a magnetic plate or other equipment, which is not limited here.

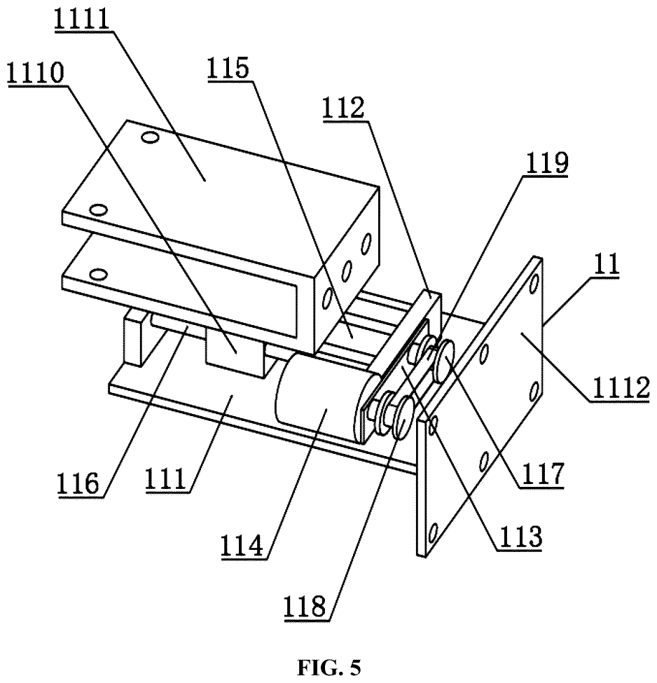

Referring to FIG. 5, the Y-axis moving assembly 11 is configured to realize the movement of the mounting and dismounting sleeve 15 in the first straight line direction to adjust its position. Specifically, the first driving mechanism includes a first sliding table 1110, a first mounting seat 1111, a first screw rod 115, a first motor 114 and two first fixed seats 112. The two first fixed seats 112 are arranged opposite to each other on the first base plate 111, and two ends of the first screw rod 115 are connected to the two first fixed seats 112 respectively, which ensures the stability and reliability of the structure and makes the entire device more secure during operation. The first motor 114 can drive the first screw rod 115 to rotate around its own axis, the first sliding table 1110 is threadedly connected to the first screw rod 115, the first mounting seat 1111 is fixedly connected to the top of the first sliding table 1110, and the first mounting seat 1111 is connected to the supporting body 1. With the threaded connection between the first sliding table 1110 and the first screw rod 115, the transmission is stable and reliable, the smoothness and accuracy of the movement can be ensured, and the supporting body 1 can be accurately driven to move in the first straight line direction, so as to achieve accurate adjustment of the position of the mounting and dismounting sleeve 15, which helps to improve the accuracy of the bolt dismounting position. Furthermore, a second mounting seat 1112 is fixedly connected to the end of the first base plate 111, so as to facilitate the connection of the first base plate 111 to the T-shaped cable clip 2.

Specifically, the first driving mechanism further includes a first driven wheel 117, a first driving wheel 118 and a first synchronous belt 119. An end of the first screw rod 115 is connected to the first driven wheel 117, an end of the first motor 114 is connected to the first driving wheel 118, and the first driving wheel 118 and the first driven wheel 117 are connected through the first synchronous belt 119. When in use, the motor shaft of the first motor 114 is driven to rotate, thereby driving the first driving wheel 118 to rotate, the first driving wheel 118 drives the first driven wheel 117 through the transmission of the first synchronous belt 119 to rotate synchronously, and the first driven wheel 117 drives the first screw rod 115 at one end thereof to rotate synchronously. Through the coordinated cooperation of the first driven wheel 117, the first driving wheel 118 and the first synchronous belt 119, the smooth transmission of the power of the first motor 114 is achieved, the accuracy and stability of the rotation of the first screw rod 115 are ensured, thereby ensuring the accuracy of movement of the mounting and dismounting sleeve 15 in the first straight line direction. The power of the motor is effectively and evenly transmitted to the first screw rod 115, energy loss is reduced, transmission efficiency is improved, and a high space utilization rate is achieved. In order to facilitate installation, a first motor plate 113 is disposed on one of the first fixed seats 112, for installing the first motor 114, the first driving wheel 118 and the first driven wheel 117.

More specifically, the first driving mechanism further includes two first guide rods 116. The first guide rods 116 are arranged parallel to the first screw rod 115 and are distributed on two sides of the first screw rod 115. The first guide rods 116 distributed on the two sides of the first screw rod 115 can balance the force, which enhances the stability and reliability of the entire Y-axis moving structure, and prevents shaking or offset during the movement. Two ends of each of the first guide rods 116 are connected to the first fixed seats 112 respectively. The first sliding table 1110 is slidably connected to the first guide rods 116. The two first guide rods 116 arranged in parallel with the first screw rod 115 can provide a better guiding effect for the movement of the first sliding table 1110, which ensures the straightness and accuracy of the movement of the mounting and dismounting sleeve 15 in the Y-axis direction, and enables the mounting and dismounting sleeve 15 to reach the target position more accurately. The first sliding table 1110 is slidably connected to the first guide rod 116, which further limits the other degrees of freedom of the first sliding table 1110 except in the first straight line direction, ensures accuracy of the movement, and is conducive to improving the accuracy and quality of the bolt dismounting operation. This facilitates improvement of the running stability of the entire Y-axis moving assembly 11 and reduction of errors or failures that may be caused by factors such as shaking, and ensures the efficient and reliable operation of the device.

Furthermore, at least one of the first guide rods 116 is provided with a limiter. Providing the limiter can effectively limit the movement range of the first sliding table 1110 on the first guide rod 116, prevent excessive movement from occurring which may cause device damage or failure, and play a role in safety protection. It can ensure that the first sliding table 1110 moves accurately within a predetermined range, ensure the controllability and stability of the operation of the entire device, and make the operation more reliable. Regarding the number of limiters provided, a limiter can be set on only one guide rod, or a limiter can be set on each guide rod, which is not limited here.

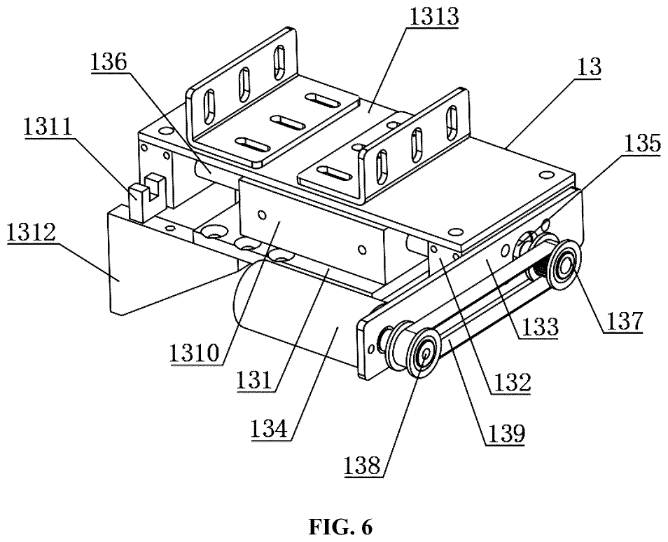

Referring to FIG. 6, the X-axis moving assembly 13 is configured to realize the movement of the mounting and dismounting sleeve 15 in the second straight line direction to adjust its position. Specifically, the second driving mechanism includes a second sliding table 1310, a second screw rod 135, a second motor 134 and two second fixed seats 132. The two second fixed seats 132 are arranged opposite to each other at the bottom of the second base plate 1313. The second screw rod 135 is supported by the two second fixed seats 132 arranged opposite to each other, which ensures the stability of the structure and makes the entire moving process more reliable. Two ends of the second screw rod 135 are connected to the two second fixed seats 132 respectively, the second motor 134 can drive the second screw rod 135 to rotate around its own axis, the second sliding table 1310 is threadedly connected to the second screw rod 135, and the adapter structure 1312 is fixedly connected to the bottom of the second sliding table 1310. When in use, a motor shaft of the second motor 134 rotates, driving the second screw rod 135 connected to the motor shaft to rotate around its own axis. Since the second sliding table 1310 is threadedly connected to the second screw rod 135, the second sliding table 1310 is driven to move in the second straight line direction, thereby driving the adapter structure 1312 connected to the second sliding table 1310 to move in the second straight line direction, and finally driving the mounting and dismounting assembly to move in the second straight line direction. The second sliding table 1310 can be accurately driven to move in the second straight line direction, so that the position of the mounting and dismounting assembly in this direction can be adjusted more flexibly and accurately, so as to better align the mounting and dismounting assembly with the to-be-dismounted bolts, and improve the accuracy and efficiency of the dismounting. The second sliding table 1310 is threadedly connected to the second screw rod 135, and the transmission is stable and reliable, which can ensure the accuracy and stability of the moving process and reduce position deviation.

Furthermore, in order to prevent components from interfering with the connection between the adapter structure 1312 and the second sliding table 1310, a bottom plate 131 is provided at the bottom of the second sliding table 1310, and the bottom plate 131 is fixedly connected to the adapter structure 1312, so that with the bottom plate 131 playing a transition role, space utilization rate is optimized, and interference between components is prevented, so as to facilitate the transmission of the power of the second sliding table 1310 to the adapter structure 1312 through the bottom plate 131.

Specifically, the second driving mechanism further includes a second driven wheel 137, a second driving wheel 138 and a second synchronous belt 139, an end of the second screw rod 135 is connected to the second driven wheel 137, an end of the second motor 134 is connected to the second driving wheel 138, and the second driving wheel 138 and the second driven wheel 137 are connected by the second synchronous belt 139. When in use, a motor shaft of the second motor 134 is driven to rotate, thereby driving the second driving wheel 138 to rotate. The second driving wheel 138 drives, through the transmission of the second synchronous belt 139, the second driven wheel 137 to rotate synchronously, and the second driven wheel 137 drives the second screw rod 135 at one end thereof to rotate synchronously.

More specifically, the second driving mechanism further includes two second guide rods 136, the two second guide rods 136 are arranged parallel to the second screw rod 135 and distributed on two sides of the second screw rod 135. Two ends of each of the second guide rods 136 are connected to the second fixed seats 132 respectively, and the second sliding table 1310 is slidably connected to the second guide rods 136. It can be understood that the function of the second guide rods 136 is the same as that of the first guide rods 116, which is not described in detail here. In order to facilitate installation, a second motor plate 133 is disposed on one of the second fixed seats 132, for installing the second motor 134, the second driving wheel 138 and the second driven wheel 137.

In order to facilitate the connection between the X-axis moving assembly 13 and the supporting body 1, two bearing plates are arranged on the top of the second base plate 1313, each of the bearing plates includes a horizontal plate and a vertical plate integrally formed, the horizontal plate and the vertical plate are arranged perpendicular to each other, the horizontal plate is fixedly connected to the second base plate 1313, and the vertical plate is fixedly connected to the supporting body 1. The arrangement of the two bearing plates provides a stable support and connection structure for the supporting body 1, ensuring the firmness of the connection between the supporting body 1 and the X-axis moving assembly 13. The fixed connection between the second base plate 1313 and the horizontal plates ensures the stability of the bearing plate installation. The fixed connection between the supporting body 1 and the vertical plates enhances the connection strength between the supporting body 1 and the bearing plates, thereby facilitating the improvement of the overall mechanical performance of the device.

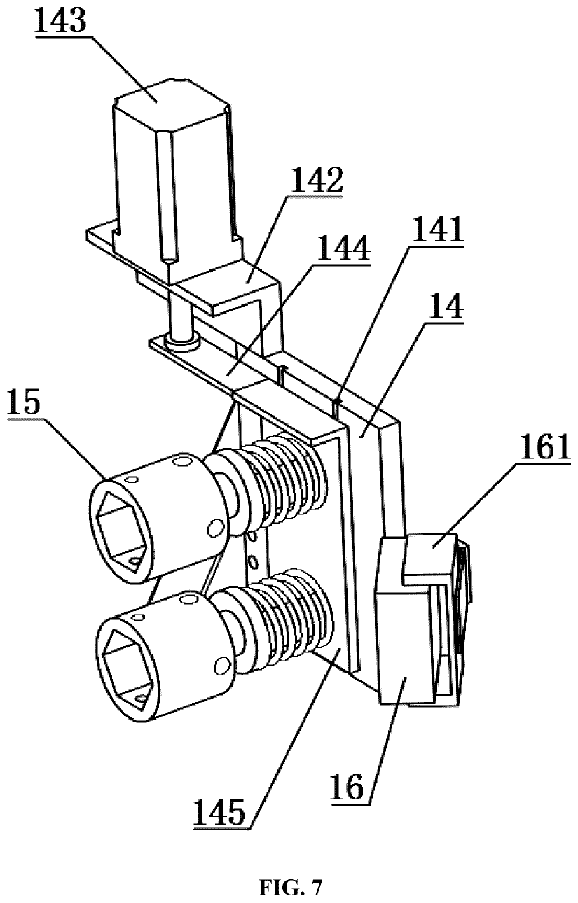

Referring to FIG. 7 to FIG. 9, regarding the mounting and dismounting assembly, the mounting and dismounting sleeve 15 includes a sleeve body 152 and a connecting clip shaft 151. One end of the connecting clip shaft 151 is connected to the sleeve body 152, and the other end of the connecting clip shaft 151 is connected to the connecting plate 145. A spring 153 is sleeved on the connecting clip shaft 151, one end of the spring 153 abuts against the sleeve body 152, and the other end of the spring 153 abuts against the connecting plate 145. The connecting clip shaft 151 reliably connects the sleeve body 152 and the connecting plate 145, ensuring effective force transmission and smooth mounting and dismounting operations. The sleeved spring 153 plays a buffering role, and when the mounting and dismounting sleeve 15 comes into contact with the bolt, the spring can reduce rigid impact, protect the sleeve body 152 and other components from damage by large impact force, and extend the service life of the device.

In order to further improve the flexibility of the mounting and dismounting sleeve 15, the third driving mechanism includes an adapter plate 14 and a third motor 143. The adapter plate 14 is fixedly connected to the adapter structure 1312. The adapter plate 14 is provided with a guide groove 141, and the guide groove 141 extends in the third straight line direction. The connecting plate 145 is correspondingly provided with a guide protrusion 146, and the guide protrusion 146 is slidably connected to the guide groove 141. A telescopic end of the third motor 143 is connected to the connecting plate 145, and the third motor 143 can drive the connecting plate 145 to move along the guide groove 141. When in use, by driving the telescopic end of the third motor 143 to extend and retract, the connecting plate 145 can be driven to slide along the guide groove 141, thereby synchronously driving the mounting and dismounting sleeve 15 arranged on the connecting plate 145 to also move in the third straight line direction. During the practical installation process, when the third motor 143 is connected to the connecting plate 145, the connection will be interfered by other components. Therefore, a transfer plate 142 is provided over the connecting plate 145. An end of the transfer plate 142 is fixedly connected to the connecting plate 145, and the top of the transfer plate 142 is connected to the telescopic end of the third motor 143, so that the space can be optimized and interference can be avoided, and the power of the third motor 143 can be transmitted to the connecting plate 145 through the transfer plate 142. In addition, in order to improve the stability of the third motor 143, the adapter plate 14 is further provided with a transition plate 144. The transition plate 144 extends in an L shape. The vertical section of the transition plate 144 is connected to the adapter plate 14, and the horizontal section of the transition plate 144 is connected to the third motor 143, thereby providing a larger contact area for the third motor 143 and improving the stability of installation of the third motor 143.

Regarding the number of the mounting and dismounting sleeves 15, in this embodiment, two threaded holes are arranged at an interval in the height direction of the drainage plate. Therefore, two mounting and dismounting sleeves 15 are provided, and the two mounting and dismounting sleeves 15 are arranged at an interval in the third straight line direction, so as to ensure that there is a mounting and dismounting sleeve 15 corresponding to each threaded hole for mounting or dismounting the to-be-dismounted bolt. In other embodiments, three, four or more mounting and dismounting sleeves 15 may also be provided, and it is only necessary to ensure that the mounting and dismounting sleeves 15 and the threaded holes are in one-to-one correspondence, which is not limited here.

In order to achieve precise matching between the mounting and dismounting sleeve 15 and the to-be-dismounted bolt, a picture of the to-be-dismounted bolt or its mounting position is taken by using the visual camera 16, and then algorithm analysis is performed to obtain three-dimensional coordinates of the bolt or its mounting position, and its three-dimensional coordinates are uploaded to the control body, and the control body drives the Y-axis moving assembly 11, the X-axis moving assembly 13 and the mounting and dismounting assembly to adjust the position of the mounting and dismounting sleeve 15 to ensure that the mounting and dismounting sleeve 15 is aligned with the to-be-dismounted bolt before the mounting and dismounting work is performed. This real-time monitoring and positioning function enhances the adaptability of the entire device to complex environments and different bolt conditions, ensuring that the bolt dismounting work can be performed efficiently and accurately under various conditions. The control body and visual camera 16 are both conventional apparatuses, and their working principles and specific structures are not described here.

With the drainage plate bolt dismounting device provided in the embodiments of the present invention, when in use, when it is required to dismount the bolt, a nut at an end of the to-be-dismounted bolt is loosened first by a nut mounting and dismounting device (the nut mounting and dismounting device is one available in the conventional technology, which is not described in detail here), then a picture of the to-be-dismounted bolt or its mounting position is taken by using the visual camera 16, then algorithm analysis is performed to obtain three-dimensional coordinates of the bolt or its mounting position, then its three-dimensional coordinates are uploaded to the control body, and the control body drives the Y-axis moving assembly 11, the X-axis moving assembly 13 and the mounting and dismounting assembly to adjust the position of the mounting and dismounting sleeve 15 to ensure that after the mounting and dismounting sleeve 15 is aligned with the to-be-dismounted bolt, the sleeve body 152 is sleeved on the to-be-dismounted nut, and the to-be-dismounted nut is attracted by the magnetic attraction part 154, and then the X-axis moving assembly 13 is driven to drive the mounting and dismounting sleeve 15 to move away from the drainage plate, thereby performing the dismounting process of the to-be-dismounted bolt, and then the drainage plate is moved through using a drainage plate moving device 4 to the ground, so as to perform the inspection and maintenance of the drainage plate. When it is required to mount the bolt, the operation method is the reverse process of the above method, which is not described in detail here.

The above embodiments are merely illustrative of the basic principles and characteristics of the present invention. The present invention is not limited to the above embodiments. Without departing from the spirit and scope of the present invention, the present invention may have various variations and modifications. Such variations and modifications are all within the scope of the present invention. The scope of protection of the present invention is defined by the attached claims and their equivalents.

What is claimed is:

1. A drainage plate bolt dismounting device, comprising:
a supporting body;
a Y-axis moving assembly, comprising a first base plate and a first driving mechanism, wherein the first base plate is connected to a T-shaped cable clip, the first driving mechanism is arranged on the first base plate, and the first driving mechanism is connected to the supporting body and is capable of driving the supporting body to move in a first straight line direction;
an X-axis moving assembly, connected to the supporting body, wherein the X-axis moving assembly comprises a second base plate, a second driving mechanism and an adapter structure, the second driving mechanism is arranged on the second base plate, and the second driving mechanism is connected to the adapter structure and is capable of driving the adapter structure to move in a second straight line direction;
a mounting and dismounting assembly connected to the adapter structure, wherein the mounting and dismounting assembly comprises a connecting plate, a third driving mechanism and a mounting and dismounting sleeve, the third driving mechanism is capable of driving the connecting plate to move in a third straight line direction, the mounting and dismounting sleeve is arranged on the connecting plate, the mounting and dismounting sleeve is provided with a magnetic attraction part therein, and the magnetic attraction part is capable of attracting a to-be-dismounted bolt; and
a monitoring component comprising a control body and a visual camera, wherein the visual camera is connected to the supporting body and faces the to-be-dismounted bolt, the visual camera is capable of acquiring an image of a to-be-dismounted bolt, and determining three-dimensional coordinates of the to-be-dismounted bolt based on the image of the to-be-dismounted bolt, and uploading the three-dimensional coordinates to the control body.

2. The drainage plate bolt dismounting device according to claim 1, wherein the first driving mechanism comprises a first sliding table, a first mounting seat, a first screw rod, a first motor and two first fixed seats, the two first fixed seats are arranged opposite to each other on the first base plate, two ends of the first screw rod are connected to the two first fixed seats respectively, the first motor is capable of driving the first screw rod to rotate around its own axis, the first sliding table is threadedly connected to the first screw rod, the first mounting seat is fixedly connected to a top of the first sliding table, and the first mounting seat is connected to the supporting body.

3. The drainage plate bolt dismounting device according to claim 2, wherein the first driving mechanism further comprises a first driven wheel, a first driving wheel (118) and a first synchronous belt, an end of the first screw rod is connected to the first driven wheel, an end of the first motor is connected to the first driving wheel (118), and the first driving wheel (118) and the first driven wheel are connected through the first synchronous belt.

4. The drainage plate bolt dismounting device according to claim 3, wherein the first driving mechanism further comprises two first guide rods, the two first guide rods are arranged parallel to the first screw rod and are distributed on two sides of the first screw rod, two ends of each of the two first guide rods are connected to the two first fixed seats respectively, and the first sliding table is slidably connected to the two first guide rods.

5. The drainage plate bolt dismounting device according to claim 4, wherein at least one of the two first guide rods is provided with a limiter.

6. The drainage plate bolt dismounting device according to claim 1, wherein the second driving mechanism comprises a second sliding table, a second screw rod, a second motor and two second fixed seats, the two second fixed seats are arranged opposite to each other at a bottom of the second base plate, two ends of the second screw rod are connected to the two second fixed seats respectively, the second motor is capable of driving the second screw rod to rotate around its own axis, the second sliding table is threadedly connected to the second screw rod, and the adapter structure is fixedly connected to a bottom of the second sliding table.

7. The drainage plate bolt dismounting device according to claim 6, wherein two bearing plates are arranged on a top of the second base plate, each of the two bearing plates comprises a horizontal plate and a vertical plate integrally formed, the horizontal plate and the vertical plate are arranged perpendicular to each other, the horizontal plate is fixedly connected to the second base plate, and the vertical plate is fixedly connected to the supporting body.

8. The drainage plate bolt dismounting device according to claim 1, wherein the mounting and dismounting sleeve comprises a sleeve body and a connecting clip shaft, one end of the connecting clip shaft is connected to the sleeve body, another end of the connecting clip shaft is connected to the connecting plate, a spring is sleeved on the connecting clip shaft, one end of the spring abuts against the sleeve body, and another end of the spring abuts against the connecting plate.

9. The drainage plate bolt dismounting device according to claim 1, wherein the third driving mechanism comprises an adapter plate and a third motor, the adapter plate is fixedly connected to the adapter structure, the adapter plate is provided with a guide groove, the guide groove extends in the third straight line direction, the connecting plate is correspondingly provided with a guide protrusion (146), the guide protrusion (146) is slidably connected to the guide groove, a telescopic end of the third motor is connected to the connecting plate, and the third motor is capable of driving the connecting plate to move along the guide groove.

10. The drainage plate bolt dismounting device according to claim 1, wherein two mounting and dismounting sleeves are provided, and the two mounting and dismounting sleeves are arranged at an interval in the third straight line direction.
